(19) United States
(12) Patent Application Publication
(10) Pub. No.: US 2019/0190585 A1
(43) Pub. Date: Jun. 20, 2019

(54) COMMUNICATION SYSTEM, COORDINATOR AND CONTROLLING METHOD THEREOF

(71) Applicant: Industrial Technology Research Institute, Hsinchu (TW)

(72) Inventors: Shih-Hao FANG, Zhubei City (TW); Jen-Yuan HSU, Jincheng Township (TW); Hung-Fu WEI, Hsinchu City (TW); Chien-Yu KAO, Sanchong City (TW)

(21) Appl. No.: 15/853,554

(22) Filed: Dec. 22, 2017

(30) Foreign Application Priority Data
Dec. 14, 2017 (TW) 106143902

(51) Int. Cl. H04B 7/08; H04B 7/06; H04L 5/00; H01Q 3/24

(52) U.S. Cl. CPC H04B 7/0868; H04B 7/0606; H04B 17/318; H01Q 3/247; H04L 5/0057

(57) ABSTRACT

A communication system, a coordinator and a controlling method thereof are provided. The embodiment of the communication system is used for one or more user equipments. The controlling method includes the following steps. A measurement of a plurality of antenna configurations corresponding to the one or more user equipments is controlled to obtain a plurality of performance values. The performance values of the antenna configurations corresponding to the one or more user equipments are recorded. An embodiment of the communication system includes a plurality of Remote Radio Heads, each of which is electronically connected to a plurality of antennas.

This application claims the benefit of Taiwan application Serial No. 106143902, filed Dec. 14, 2017, the disclosure of which is incorporated by reference herein in its entirety.

### TECHNICAL FIELD

The disclosure relates in general to a communication system, a coordinator and a controlling method thereof.

### BACKGROUND

In a traditional WiFi system adopted the smart antenna technology, a plurality of antennas with different radiation directions are disposed in a base station for selection. An antenna selection method is provided to select the best antenna for improving the data communication efficiency. However, the smart antenna technology was adapted in a single base station and only one antenna in the system can be used for communication. Therefore, the diversity cannot be improved. Moreover, an antenna array may be used for improving the data communication efficiency. However, the antenna size of the antenna array is huge and the corresponding implementation cost is expensive, so it is not applicable for the small cell.

### SUMMARY

The disclosure is directed to a communication system, a coordinator and a controlling method thereof.

According to one embodiment, a controlling method of a communication system is provided. The communication system includes a plurality of Remote Radio Heads (RRHs). Each of the RRHs is electrically connected to a plurality of antennas. The communication system is used for one or more user equipments. The controlling method includes the following steps. A measurement of a plurality of antenna configurations corresponding to each of the one or more user equipments is controlled to obtain a plurality of performance values. The performance values of the antenna configurations corresponding to the one or more user equipments are recorded.

According to another embodiment, a communication system is provided. The communication system is used for one or more user equipments. The communication system includes a plurality of Remote Radio Heads (RRHs) and a coordinator. Each of the RRHs is electrically connected to a plurality of antennas. The coordinator includes a performance measuring unit and a storing unit. The performance measuring unit is used for controlling a measurement of a plurality of antenna configurations corresponding to the one or more user equipments to obtain a plurality of performance values. The storing unit is used for recording the performance values of the antenna configurations corresponding to the one or more user equipments.

According to an alternative embodiment, a coordinator is provided. The coordinator is used for coordinating a communication system which is used for one or more user equipments. The communication system includes a plurality of Remote Radio Heads (RRHs). Each of the RRHs is electrically connected to a plurality of antennas. The coordinator includes a performance measuring unit and a storing unit. The performance measuring unit is used for controlling a measurement of a plurality of antenna configurations corresponding to the one or more user equipments to obtain a plurality of performance values. The storing unit is used for recording the performance values of the antenna configurations corresponding to the one or more user equipments.

### BRIEF DESCRIPTION OF THE DRAWINGS

FIG. 1 shows a communication system according to one embodiment

FIG. 2 shows a block diagram of the communication system.

FIG. 3 shows a flowchart of a measuring method of a plurality of antenna configurations according to one embodiment.

FIG. 4 shows a flowchart of an allocating method of the antenna configurations according to one embodiment.

FIGS. 5A to 5B show a flowchart of another measuring method of the antenna configurations according to another embodiment.

FIG. 6 shows a flowchart of another allocating method of the antenna configurations according to another embodiment.

FIG. 7 shows another allocating method of the antenna configurations according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

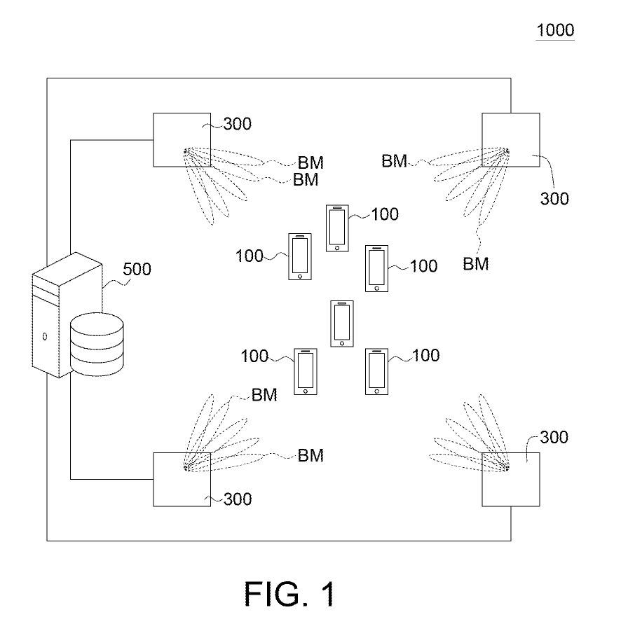

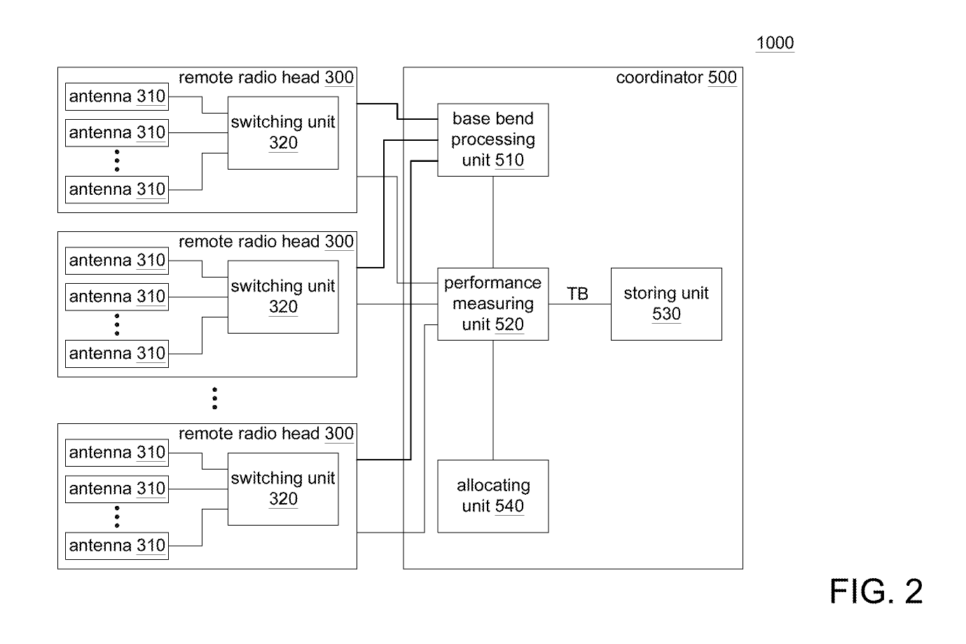

Please refer to FIG. 1 which shows a communication system 1000 according to one embodiment. The communication system 1000 including a plurality of Remote Radio Heads (RRHs) 300 and a coordinator 500 serves for one or more user equipment(s) 100. Each of the RRHs 300 is electrically connected to a plurality of antennas 310 (shown in FIG. 2), each of which is a directional antenna. Each of the RRHs 300 adopts the smart antenna technology to dispose more than one antennas 310 at a board or a pillar. The antennas 310 have different radiation directions. In FIG. 1, beams BM of the antennas 310 are respectively shown. One or more antennas 310 connected to each of the RRHs 300 can be selected to form an antenna configuration. Please refer to table I, which illustrates a plurality antenna configurations formed by four RRHs 300 each of which is connected to three antennas 310. The antenna configuration formed by the first antenna 310 of the first RRH 300, the first antenna 310 of the second RRH 300, the second antenna 310 of the third RRH 300 and the first antenna 310 of the fourth RRH 300 is recorded as “(100,100,010,100).” The antenna configuration formed by the first antenna 310 and the second antenna 310 of the first RRH 300, the first antenna 310 and the third antenna 310 of the second RRH 300, the second antenna 310 and the third antenna of the third RRH 300, and the first to third antennas 310 of the fourth RRH 300 is recorded as “(110,101,011,111).” That is to say, in this example, (2³−1)*(2³−1)*(2³−1)*(2³−1), i.e. 2401, kinds of antenna configurations can be formed. The communication system 1000 serves the user equipments 100 via the antenna configurations.

TABLE I

| First RRH 300 | | | Second RRH 300 | | | Third RRH 300 | | | Fourth RRH 300 | | |
|---|---|---|---|---|---|---|---|---|---|---|---|
| 1st | 2nd | 3th | 1st | 2nd | 3th | 1st | 2nd | 3th | 1st | 2nd | 3th |
| antenna | antenna | antenna | antenna | antenna | antenna | antenna | antenna | antenna | antenna | antenna | antenna |
| 1 | 0 | 0 | 1 | 0 | 0 | 1 | 0 | 0 | 1 | 0 | 0 |
| 0 | 1 | 0 | 1 | 0 | 0 | 1 | 0 | 0 | 1 | 0 | 0 |

. . .

| | | | | | | | | | | | |
|---|---|---|---|---|---|---|---|---|---|---|---|
| 1 | 1 | 1 | 1 | 0 | 0 | 1 | 0 | 0 | 1 | 0 | 0 |
| 1 | 1 | 1 | 0 | 1 | 0 | 1 | 0 | 0 | 1 | 0 | 0 |

. . .

| | | | | | | | | | | | |
|---|---|---|---|---|---|---|---|---|---|---|---|
| 1 | 1 | 1 | 1 | 1 | 1 | 1 | 0 | 0 | 1 | 0 | 0 |

. . .

| | | | | | | | | | | | |
|---|---|---|---|---|---|---|---|---|---|---|---|
| 1 | 1 | 1 | 1 | 1 | 1 | 1 | 1 | 1 | 1 | 0 | 0 |

. . .

| | | | | | | | | | | | |
|---|---|---|---|---|---|---|---|---|---|---|---|
| 1 | 1 | 1 | 1 | 1 | 1 | 1 | 1 | 1 | 1 | 1 | 1 |

Please refer to FIG. 2, which shows a block diagram of the communication system 100. As shown in FIG. 2, each of the RRHs 300 includes a switching unit 320 and is electrically connected to or includes several antennas 310. The switching unit 320 is used for switching the antennas 310. For example, the switching unit 320 may be a circuit board, a chip, a mechanical component, or a firmware (or a computer program) having controlling codes which controls the switching with the RF module. The coordinator 500 includes a base bend processing unit 510, a performance measuring unit 520, a storing unit 530 and an allocating unit 540. The base bend processing unit 510 is used for processing signal, such as the analog to digital conversion, the signal decoding, the channel estimation, the Carrier Frequency Offset Estimation (CFO Estimation), or the Sampling Frequency Offset Estimation (SFO Estimation).

The performance measuring unit 520 is used for controlling the measurement of the antennas 310. The performance measuring unit 520 may indicate the performance via the Channel Quality Indicator (CQI), Signal-to-Interference-plus-Noise Ratio (SINR), the Signal-to-Noise Ratio (SNR), the Received Signal Strength Indicator (RSSI), the Reference Signal Received Quality (RSRQ), the Reference Signal Received Power (RSRP) or the Throughput. The storing unit 530 is used for storing various data. For example, the storing unit 530 may be a memory, a hard disk or a storage unit in a cloud data center. The allocating unit 540 is used for allocating the antenna configurations. For example, the performance measuring unit 520 and the allocating unit 540 may be a circuit, a chip, a circuit board a firmware or a non-transitory computer readable medium.

The communication system 1000 of the present embodiment can measure and allocate the antenna configurations of the antennas 310 connected to the RRHs 300, such that the signal strength and the signal coverage can be improved and is applicable to be used in the 5G communication system. The measurement of the antenna configurations and the allocation of the antenna configurations are illustrated via several flowcharts.

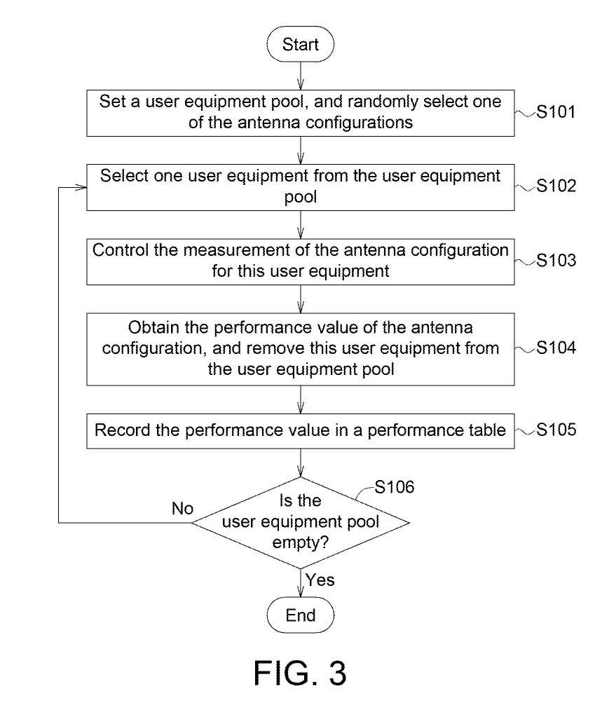

Please refer to FIG. 3, which shows a flowchart of a measuring method of the antenna configurations according to one embodiment. In step S101, the performance measuring unit 520 sets a user equipment pool, and randomly selects one of the antenna configurations. The user equipment pool contains all of the user equipments 100 needed to be measured.

The performance measuring unit 520 selects one user equipment 100 from the user equipment pool (step S102). And, the performance measuring unit 520 controls the measurement of the antenna configuration for this user equipment 100 (step S103).

In step S104, after the performance measuring unit 520 obtains the performance value of the antenna configuration, this user equipment 100 is removed from the user equipment pool. For example, the performance value may be measured by the performance measuring unit 520, or received from this user equipment 100.

In step S105, the performance measuring unit 520 records the performance value in a performance table TB, and stores the performance table TB in the storing unit 530. An embodiment, in the performance table TB, for each of the user equipment 100, may records only the best N performance values. N is larger than or equal to 1. For example, please refer to table II, which illustrates the performance table TB of one user equipment 100.

TABLE II

| antenna | performance |
|---|---|
| configuration | value |
| (100,100,010,100) | 90 |
| (010,100,010,010) | 75 |
| (010,100,010,001) | 25 |
| (010,010,010,100) | 10 |
| (001,010,010,010) | 85 |

In step S106, the performance measuring unit 520 determines whether the user equipment pool is empty or not. If the user equipment pool is not empty, there is another user equipment 100 needed to be measured and the process returns to the steps S102 to S105 to obtain another performance table TB similar to the table II. When the user equipment pool is empty, all of the user equipments 100 are measured. The steps S101 to S106 are repeatedly performed until the number of the antenna configurations measured for the user equipments 100 reaches a predetermined number.

According to the measuring method of the antenna configurations, for each of the user equipments 100, the performance values of the antenna configurations can be measured. The performance values of the antenna configurations for the user equipments 100 can be recorded. Please refer to table III, the performance values measured for the user equipments 100 can be integrated into one performance table TB.

TABLE III

| antenna | user equipment | | | | |
|---|---|---|---|---|---|
| configuration | A | B | C | D | E |
| (100,100,010,100) | 90 | 70 | 50 | 30 | 90 |
| (010,100,010,010) | 75 | 85 | 70 | 40 | 75 |
| (010,100,010,001) | 25 | 80 | 95 | 75 | 20 |
| (010,010,010,100) | 10 | 50 | 70 | 80 | 10 |
| (001,010,010,010) | 85 | 65 | 45 | 25 | 85 |
| (001,001,010,001) | 20 | 75 | 90 | 80 | 15 |
| (001,010,010,001) | 5 | 45 | 65 | 75 | 5 |
| (001,100,010,001) | 80 | 60 | 40 | 20 | 80 |

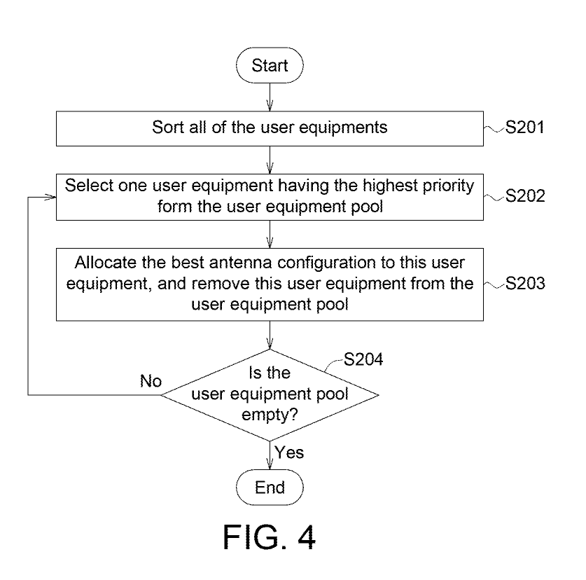

After obtaining the performance values of the antenna configurations, the antenna configurations can be allocated to the user equipments 100. Please refer to FIG. 4, which shows a flowchart of an allocating method of the antenna configurations according to one embodiment. In step S201, the allocating unit 540 sorts all of the user equipments 100.

Then, in step S202, the allocating unit 540 selects one user equipment 100 having the highest priority form the user equipment pool. For example, the user equipment 100 labeled as “A” has the highest priority.

Then, in step S203, the best antenna configuration is selected from the performance table TB and is allocated to this user equipment 100. For example, the antenna configuration which is “(100,100,010,100)” is allocated to the user equipment 100 labeled as “A.” And, the user equipment 100 labeled as “A” is removed from the user equipment pool.

In step S204, the allocating unit 540 determines whether the user equipment pool is empty or not. When the user equipment pool is empty, all of the user equipments 100 are allocated.

The allocating method of the antenna configurations described above may be performed repeatedly, until all of the user equipments 100 are allocated sequentially. According to the allocating method of the antenna configurations, the antenna configurations can be appropriately allocated to the user equipments 100 according to the performance values. If one antenna configuration is allocated to more than one user equipments 100, then the user equipments 100 can use this antenna configuration in a time-divided manner or prevent from interference.

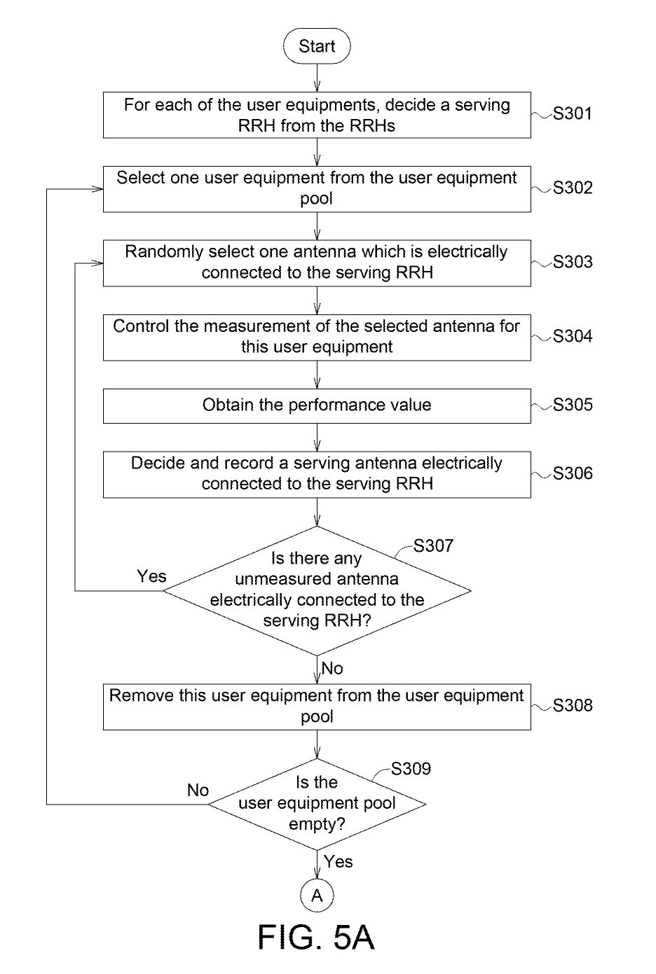

The measuring method of the antenna configuration according to one embodiment and the allocating method of the antenna configuration according to one embodiment have been disclosed above. However, the measuring method of the antenna configuration and the allocating method of the antenna configuration may be performed in other ways. In another embodiment, a region distribution technology may be used to reduce the number of measurements in the measuring method. Please refer to FIGS. 5A to 5B, which show a flowchart of another measuring method of the antenna configuration according to another embodiment. FIGS. 5A to 5B are illustrated with the block diagram of FIG. 2. In step S301, for each of the user equipments 100, the performance measuring unit 520 decides a serving RRH 300 from the RRHs 300. The serving RRH may be the RRH 300 which is closest to this user equipment 100, or the RRH 300 which has the strongest signal received from this user equipment 100.

In step S302, the performance measuring unit 520 selects one user equipment 100 from the user equipment pool.

In step S303, the performance measuring unit 520 randomly selects one antenna 310 which is electrically connected to the serving RRH 300.

In the step S304, the performance measuring unit 520 controls the measurement of the selected antenna 310 for this user equipment 100.

In step S305, the performance measuring unit 520 obtains the performance value. For example, the performance value may be measured by the performance measuring unit 520, or received from this user equipment 100 via the selected antenna 310.

In step S306, the performance measuring unit 520 decides and records a serving antenna electrically connected to the serving RRH 300 which is the best antenna.

In S307, the performance measuring unit 520 determines whether there is any unmeasured antenna 310 electrically connected to the serving RRH 300. If there is any unmeasured antenna 310, the steps S303 to S306 are repeated performed, until the serving antenna 310 is decided.

In step S308, the performance measuring unit 520 removes this user equipment 100 from the user equipment pool.

Then, in step S309, the performance measuring unit 520 determines whether the user equipment pool is empty or not. If the user equipment pool is not empty, there are other user equipments needed to be measured and the process returns to the steps S302 to S308, to decide the serving RRH 300 and the serving antenna 310 for each of the user equipments 100.

In step S310, the performance measuring unit 520 initializes the user equipment pool.

Then, in step S311, the performance measuring unit 520 selects one user equipment 100 from the user equipment pool.

In the step S312, for this user equipment, the performance measuring unit 520 selects some of the antenna configurations including the serving antenna 310 electrically connected to the serving RRH 300.

In step S313, the performance measuring unit 520 controls the measurement of the antenna configuration for this user equipment 100.

In step S314, the performance measuring unit 520 obtains the performance value of the antenna configuration. For example, the performance value may be measured by the performance measuring unit 520, or received from this user equipment 100 via the antenna configuration.

Then, in step S315, the performance measuring unit 520 records the performance values in the performance table TB, and stores the performance table TB in the storing unit 530. In the performance table TB, for the each of the user equipments 100, the best N performance values may be recorded. N is larger than or equal to 1. For example, please refer to table IV, which illustrates the performance table TB of one user equipment 100.

TABLE IV

| Antenna | performance |
|---|---|
| configuration | value |
| (100,100,010,100) | 90 |
| (100,100,010,010) | 70 |
| (100,100,010,001) | 20 |
| (100,010,010,100) | 5 |
| (100,010,010,010) | 80 |

In step S316, the performance measuring unit 520 removes this user equipment 100 from the user equipment pool.

Afterwards, in step S317, the performance measuring unit 520 determines whether the user equipment pool is empty or not. If the user equipment pool is not empty, there is another user equipment 100 needed to be measured and the process returns to the steps S311 to S316 to obtain another performance table TB similar to the table IV. When the user equipment pool is empty, all of the user equipments 100 are measured.

That is to say, after deciding the serving antenna 310 connected to the serving RRH 300 in the steps S301 to S309, only the combinations of the serving antenna 310 and other antenna 310 are needed to be measured, the number of the measurement is greatly reduced.

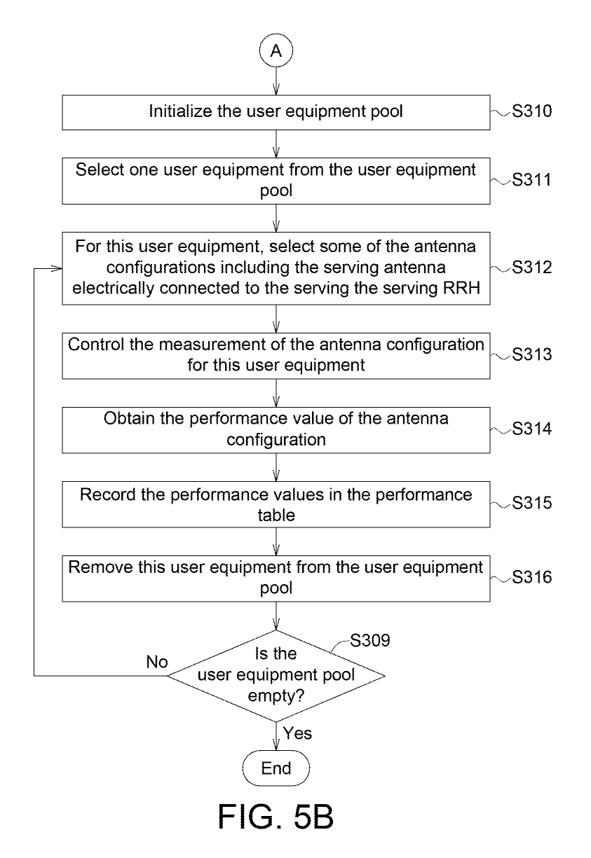

Moreover, in another embodiment, an averaging algorithm can be used in the allocating method to reduce the antenna switch frequency of the antenna configurations. Please refer to FIG. 6, which shows a flowchart of another allocating method of the antenna configurations according to another embodiment. In step S401, the allocating unit 540 calculates the performance average of the performance values corresponding to the user equipments 100 for each of the antenna configurations. For example, the performance averages corresponding to the user equipments labeled “A” to “E” for the antenna configurations are illustrated in table V.

TABLE V

| antenna | user equipment | | | | | performance | |
|---|---|---|---|---|---|---|---|
| configuration | A | B | C | D | E | average | rank |
| (100, 100, 010, 100) | 90 | 70 | 50 | 30 | 90 | 66 | 2 |
| (010, 100, 010, 010) | 75 | 85 | 70 | 40 | 75 | 69 | 1 |
| (010, 100, 010, 001) | 25 | 80 | 95 | 75 | 20 | 59 | 4 |
| (010, 010, 010, 100) | 10 | 50 | 70 | 80 | 10 | 44 | 7 |
| (001, 010, 010, 010) | 85 | 65 | 45 | 25 | 85 | 61 | 3 |
| (001, 001, 010, 001) | 20 | 75 | 90 | 80 | 15 | 59 | 4 |
| (001, 010, 010, 001) | 5 | 45 | 65 | 75 | 5 | 39 | 8 |
| (001, 100, 010, 001) | 80 | 60 | 40 | 20 | 80 | 56 | 6 |

In step S402, the allocating unit 540 sorts the antenna configurations.

Then, in step S403, the allocating unit 540 allocates the best antenna configuration, such as “(010,100,010,010)”, to the user equipments 100 labeled “A” to “E”.

Therefore, by performing this allocating method of the antenna configurations, the antenna configuration having the best performance value can be allocated to all of the user equipments 100, such that the allocated antenna configuration is not needed to be switched often.

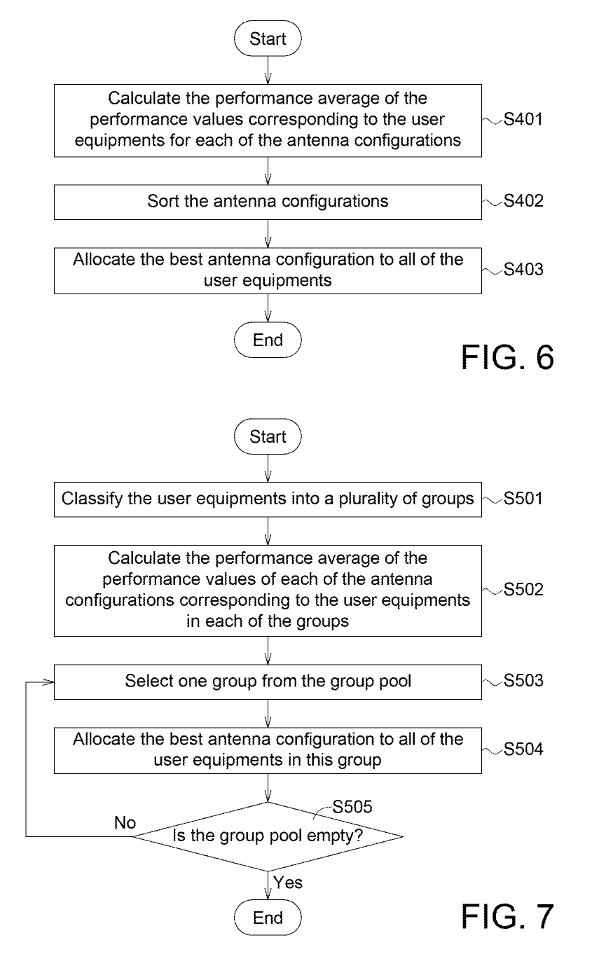

Furthermore, in another embodiment, a grouping technology can be used in the allocating method of the antenna configuration to achieve the advantages of FIGS. 4 and 6. Please refer to FIG. 7, which shows another allocating method of the antenna configurations according to another embodiment. In step S501, the allocating unit 540 classifies the user equipments 100 into a plurality of groups. For example, the user equipments 100 correspond to the same serving RRH 300 may be classified into the same group. Or, the user equipments 100 located closely may be classified into the same group.

In the step S502, the allocating unit 540 calculates the performance average of the performance values of each of the antenna configurations corresponding to the user equipments 100 in each of the groups. For example, the performance averages corresponding to the user equipments 100 in difference groups are illustrated in table VI.

TABLE VI

| | group | | | group | | | |
|---|---|---|---|---|---|---|---|
| | user | | perfor- | user | | | perfor- |
| antenna | equipment | | mance | equipment | | | mance |
| configuration | A | C | average | B | D | E | average |
| (100, 100, 010, 100) | 90 | 50 | 70 | 70 | 30 | 90 | 63 |
| (010, 100, 010, 010) | 75 | 70 | 73 | 85 | 40 | 75 | 67 |
| (010, 100, 010, 001) | 25 | 95 | 60 | 80 | 75 | 20 | 58 |
| (010, 010, 010, 100) | 10 | 70 | 40 | 50 | 80 | 10 | 47 |
| (001, 010, 010, 010) | 85 | 45 | 65 | 65 | 25 | 85 | 58 |
| (001, 001, 010, 001) | 20 | 90 | 55 | 75 | 80 | 15 | 57 |
| (001, 010, 010, 001) | 5 | 65 | 35 | 45 | 75 | 5 | 42 |
| (001, 100, 010, 001) | 80 | 40 | 60 | 60 | 20 | 80 | 53 |

In step S503, the allocating unit 540 selects one group from a group pool.

Then, in step S504, the allocating unit 540 allocates the best antenna configuration to all of the user equipments 100 in this group. After allocating, the allocating unit 540 removes this group from the group pool. For example, in the group including the user equipments 100 labeled “A” and “C”, the best antenna configuration is “(010,100,010,010)”, so this antenna configuration is allocated to the user equipments labeled “A” and “C.”

In step S505, the allocating unit 540 determines whether the group pool is empty or not. If the group pool is not empty, there is another group needed to be allocated and the process returns to steps S503 to S504 for allocating the another group. When the group pool is empty, all of the user equipments 100 in all of the groups are allocated.

By performing the allocating method of the antenna configurations, the antenna configuration can be appropriately allocated to the user equipments 100 according to the performance values. If one antenna configuration is allocated to more than one user equipments 100, then the user equipments 100 can use this antenna configuration in a time-divided manner for prevent from interference.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A controlling method of a communication system, wherein the communication system is used for one or more user equipments, and the controlling method comprises:
controlling a measurement of a plurality of antenna configurations corresponding to each of the one or more user equipments to obtain a plurality of performance values; and
recording the performance values of the antenna configurations corresponding to the one or more user equipments,
wherein the communication system includes a plurality of Remote Radio Heads (RRHs), and each of the RRHs is electrically connected to a plurality of antennas.

2. The controlling method of the communication system according to claim 1, wherein in the step of recording the performance values, for each of the one or more user equipments, the best N performance values are recorded, and N is larger than or equal to 1.

3. The controlling method of the communication system according to claim 1, wherein in the step of controlling the measurement of the antenna configurations, for each of the one or more user equipments, the antenna configurations are randomly selected to be measured.

4. The controlling method of the communication system according to claim 1, further comprising:
deciding a serving RRH from the RRHs for each of the one or more user equipments; and
deciding a serving antenna from the antennas electronically connected to the serving RRH for each of the one or more user equipments,
wherein in the step of controlling the measurement of the antenna configurations, for each of the one or more user equipments, some of the antenna configurations including the serving antenna are selected to be measured.

5. The controlling method of the communication system according to claim 1, further comprising:
allocating the antenna configurations to the one or more user equipments according to the performance values.

6. The controlling method of the communication system according to claim 5, wherein in the step of allocating the antenna configurations, the one or more user equipments are sequentially allocated to use the antenna configurations.

7. The controlling method of the communication system according to claim 5, further comprising:
calculating a performance average of the performance values of each of the antenna configurations corresponding to the one or more user equipments,
wherein in the step of allocating the antenna configurations, one of the antenna configurations is allocated to all of the one or more user equipments according to the performance averages.

8. The controlling method of the communication system according to claim 5, wherein the number of the one or more user equipments is more than one, and the controlling method further comprises:
classifying the user equipments into a plurality of groups; and
calculating a performance average of the performance values of each of the antenna configurations corresponding to the user equipments in each of the groups,
wherein in the step of allocating the antenna configurations, for each of the groups, one of the antenna configurations is allocated to all of the user equipments in this one of the groups according to the performance averages.

9. A communication system, used for one or more user equipments, the communication system comprising:
a plurality of Remote Radio Heads (RRHs), each of which is electrically connected to a plurality of antennas; and
a coordinator, comprising:
a performance measuring unit, used for controlling a measurement of a plurality of antenna configurations corresponding to the one or more user equipments to obtain a plurality of performance values; and
a storing unit, used for recording the performance values of the antenna configurations corresponding to the one or more user equipments.

10. The communication system according to claim 9, wherein for each of the one or more user equipments, the coordinator records the best N performance values in the storing unit, and N is larger than or equal to 1.

11. The communication system according to claim 9, wherein for each of the one or more user equipments, the performance measuring unit randomly selects the antenna configurations to be measured.

12. The communication system according to claim 9, wherein for each of the one or more user equipments, the performance measuring unit decides a serving RRH from the RRHs, decides a serving antenna from the antennas electronically connected to the serving RRH, and selects some of the antenna configurations including the serving antenna to be measured.

13. The communication system according to claim 9, wherein the coordinator further comprises:
an allocating unit, used for allocating the antenna configurations to the one or more user equipments according to the performance values.

14. The communication system according to claim 13, wherein the allocating unit sequentially allocates the one or more user equipments to use the antenna configurations.

15. The communication system according to claim 13, wherein the allocating unit calculates a performance average of the performance values of each of the antenna configurations corresponding to the one or more user equipments, and allocates one of the antenna configurations to all of the one or more user equipments according to the performance averages.

16. The communication system according to claim 13, wherein the number of the one or more user equipments is more than one, the allocating unit classifies the user equipments into a plurality of groups, and calculates a performance average of the performance values of each of the antenna configurations corresponding to the user equipments in each of the groups; and for each of the groups, the allocating unit allocates one of the antenna configurations to all of the user equipments in this one of the groups according to the performance averages.

17. A coordinator, wherein the coordinator is used for coordinating a communication system which is used for one or more user equipments, and the coordinator comprises:
a performance measuring unit, used for controlling a measurement of a plurality of antenna configurations corresponding to the one or more user equipments to obtain a plurality of performance values; and
a storing unit, used for recording the performance values of the antenna configurations corresponding to the one or more user equipments,
wherein the communication system includes a plurality of Remote Radio Heads (RRHs), and each of the RRHs is electrically connected to a plurality of antennas.

18. The coordinator according to claim 17, wherein for each of the one or more user equipments, the coordinator records the best N performance values in the storing unit, and N is larger than or equal to 1.

19. The coordinator according to claim 17, wherein for each of the one or more user equipments, the performance measuring unit randomly selects the antenna configurations to be measured.

20. The coordinator according to claim 17, wherein for each of the one or more user equipments, the performance measuring unit decides a serving RRH from the RRHs, decides a serving antenna from the antennas electronically connected to the serving RRH, and selects some of the antenna configurations including the serving antenna to be measured.

21. The coordinator according to claim 17, further comprising:
an allocating unit, used for allocating the antenna configurations to the one or more user equipments according to the performance values.

22. The coordinator according to claim 21, wherein the allocating unit sequentially allocates the one or more user equipments to use the antenna configurations.

23. The coordinator according to claim 21, wherein the allocating unit calculates a performance average of the performance values of each of the antenna configurations corresponding to the one or more user equipments, and allocates one of the antenna configurations to all of the one or more user equipments according to the performance averages.

24. The coordinator according to claim 21, wherein the number of the one or more user equipments is more than one, the allocating unit classifies the user equipments into a plurality of groups, and calculates a performance average of the performance values of each of the antenna configurations corresponding to the user equipments in each of the groups; and for each of the groups, the allocating unit allocates one of the antenna configurations to all of the user equipments in this one of the groups according to the performance averages.
